(19) United States
(12) Patent Application Publication
(10) Pub. No.: US 2026/0012406 A1
(43) Pub. Date: Jan. 8, 2026

(54) SILENT FAILURE DETECTION DEVICE AND SILENT FAILURE DETECTION METHOD

(71) Applicant: Fujitsu Limited, Kawasaki-shi (JP)

(72) Inventor: Takahiro FURUKAWA, Kawasaki (JP)

(73) Assignee: Fujitsu Limited, Kawasaki-shi,Kanagawa (JP)

(21) Appl. No.: 19/189,325

(22) Filed: Apr. 25, 2025

(30) Foreign Application Priority Data
Jul. 8, 2024 (JP) 2024-109477

(51) Int. Cl. H04L 43/0817; H04L 43/10; H04L 47/32

(52) U.S. Cl. CPC H04L 43/0817; H04L 43/10; H04L 47/32

(57) ABSTRACT

A silent failure detection device includes a memory, and a processor coupled to the memory and configured to: periodically acquire performance monitor information indicating a communication status from each of a plurality of network devices constituting a communication network; and detect a silent failure occurring in the communication network based on the performance monitor information acquired, wherein the processor is further configured to: determine values of a plurality of failure determination parameters based on the performance monitor information; and determine whether a silent failure has occurred in the communication network based on a failure determination score calculated from the values of the plurality of failure determination parameters.

### CROSS-REFERENCE TO RELATED APPLICATION

This application is based upon and claims the benefit of priority of the prior Japanese Patent Application No. 2024-109477, filed on Jul. 8, 2024, the entire contents of which are incorporated herein by reference.

### FIELD

A certain aspect of embodiments described herein relates to a device and method for detecting silent failures occurring in a communication network.

### BACKGROUND

In many cases, communication networks have the function to detect failures and output error messages. In this case, since the location of the failure is identified based on the error message, the administrator of the communication network can deal with the failure at an early stage.

However, not all failures are detected, and an error message may not be output even though a failure has occurred. In the following description, such failures are sometimes referred to as “silent failures”. The silent failure includes not only a case where a failure actually occurs but also a “sign of failure”.

Under these circumstances, a failure detection device has been proposed to detect failures occurring in a communication network at an early stage when their effects are relatively small, at a low cost as disclosed in, for example, Japanese Patent Application Laid-Open No. 2005-072723 (Patent Document 1). Further, related techniques are described in Japanese Patent Application Laid-Open No. 2009-017393 (Patent Document 2), U.S. Patent Application Publication No. 2018/0227208 (Patent Document 3), Internal Publication No. 2023/084599 (Patent Document 4), and Japanese Patent Application Laid-Open No. 2003-244146 (Patent Document 5).

### SUMMARY

According to an aspect of the embodiments, there is provided a silent failure detection device including: a memory; and a processor coupled to the memory and configured to: periodically acquire performance monitor information indicating a communication status from each of a plurality of network devices constituting a communication network; and detect a silent failure occurring in the communication network based on the performance monitor information acquired, wherein the processor is further configured to: determine values of a plurality of failure determination parameters based on the performance monitor information; and determine whether a silent failure has occurred in the communication network based on a failure determination score calculated from the values of the plurality of failure determination parameters.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a communication network in which a silent failure detection device according to an embodiment is used.

FIG. 2 is a diagram illustrating a configuration of a network device.

FIG. 3 is a diagram illustrating a functional configuration of a silent failure detection device.

FIG. 4 illustrates counter difference values calculated by a difference calculation unit.

FIG. 5 is a flowchart illustrating a process for detecting a silent failure.

FIG. 6 is a diagram illustrating a difference information management table.

FIG. 7 is a flowchart illustrating a cancellation process.

FIG. 8 is a diagram illustrating a use case for verifying the procedure of the flowchart illustrated in FIG. 5.

FIG. 9 is a diagram illustrating a hardware configuration of the silent failure detection device.

### DESCRIPTION OF EMBODIMENTS

Techniques have been proposed to detect silent failures as described above. However, in the present situation, the silent failure often affects communications. Therefore, a method for detecting silent failures with higher accuracy is required.

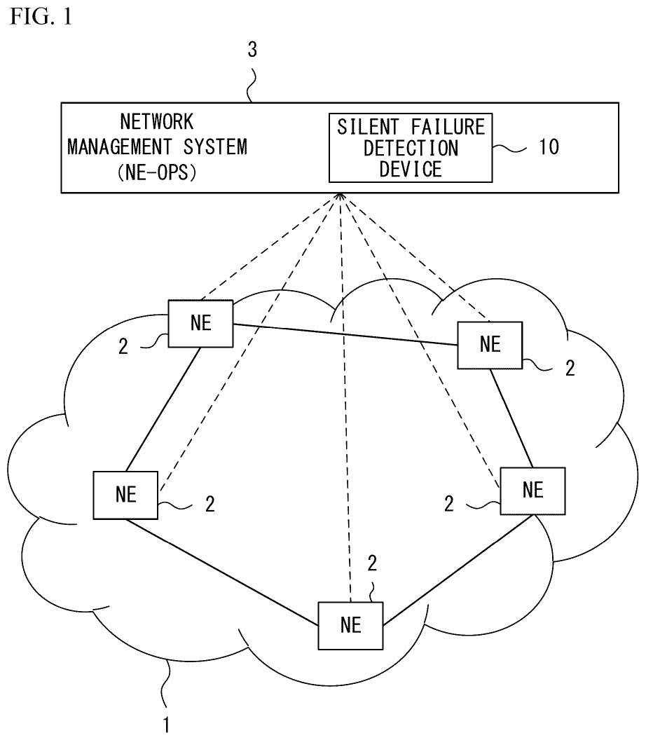

FIG. 1 illustrates a communication network in which a silent failure detection device according to an embodiment is used. A communication network 1 according to the embodiment includes a network device (NE: Network Element) 2 in each node. The network device 2 transmits optical signals in the physical layer. The optical signal may be a wavelength division multiplexed (WDM) signal. The network device 2 can also transmit and receive packets. The packet may be, for example, an IP packet.

A network management system (NE-OPS: Network Element Operation System) 3 monitors the status of the communication network 1 and controls the operation of each network device 2. At this time, the network management system 3 may collect performance monitor information from each network device 2. In this case, the performance monitor information represents the communication status detected or measured in each network device 2.

The silent failure detection device 10 is implemented in the network management system 3. The silent failure detection device 10 periodically acquires the performance monitor information from each network device 2. Then, the silent failure detection device 10 determines whether a silent failure is occurring in each network device 2 based on the acquired performance monitor information.

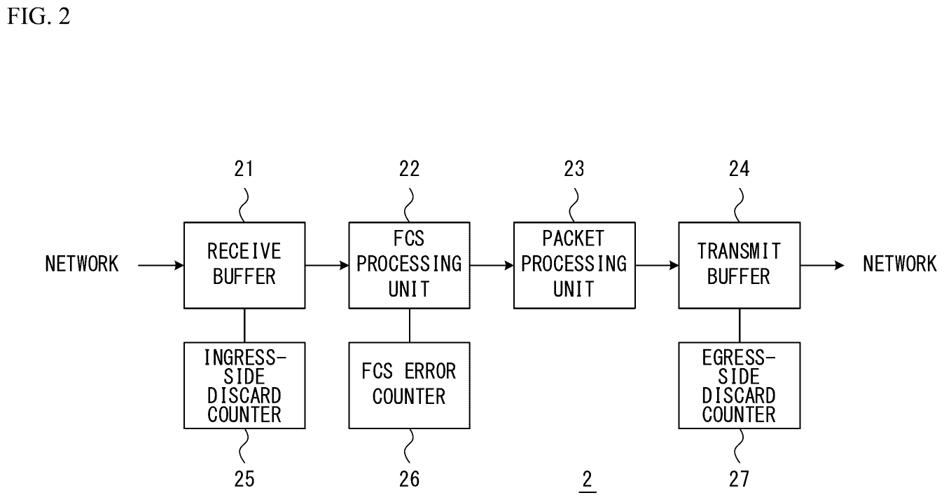

FIG. 2 illustrates a configuration of the network device 2. The network device 2 includes a receive buffer 21, an FCS (Frame Check Sequence) processing unit 22, a packet processing unit 23, a transmit buffer 24, an Ingress-side discard counter 25, an FCS error counter 26, and an Egress-side discard counter 27. The network device 2 may include other functions or circuits not illustrated in FIG. 2. In the example illustrated in FIG. 2, the network device 2 includes one input port and one output port, but may include a plurality of input ports and a plurality of output ports.

Packets arriving at the network device 2 via the communication network 1 are written to the receive buffer 21. At this time, the header of the incoming packet is checked. For example, the destination address and the source address set in the header of the incoming packet are checked. When the destination address and the source address of the incoming packet are the same, it means that the packet sent by the network device 2 has returned to the network device 2. That is, it is determined that a loop error has occurred.

The FCS processing unit 22 detects an FCS error by using the frame check sequence of the incoming packet. The FCS processing unit 22 may correct the detected error.

The packet processing unit 23 processes the incoming packet based on the header or overhead of the incoming packet. Then, the packet to be transmitted to the other network device 2 is written to the transmit buffer 24. The packets written to the transmit buffer 24 are sequentially output to the communication network 1.

The Ingress-side discard counter 25 counts the number of packets discarded in the receive buffer 21. The incoming packets written to the receive buffer 21 are read at a predetermined rate and processed by the packet processing unit 23. Therefore, when the packet reception rate exceeds a predetermined threshold value, an overflow occurs in the receive buffer 21, and some of the incoming packets are discarded. When the loop error described above is detected, the packet is discarded in the receive buffer 21.

The FCS error counter 26 counts the number of FCS errors detected by the FCS processing unit 22. In this embodiment, it is assumed that the incoming packet in which an FCS error has been detected is discarded. In this case, the FCS error counter 26 counts the number of packets discarded due to the FCS error. The Egress-side discard counter 27 counts the number of packets discarded in the transmit buffer 24. The packets written to the transmit buffer 24 are read at a predetermined rate and output to the communication network 1. Therefore, when packets of an amount exceeding an expected amount are transmitted, an overflow occurs in the transmit buffer 24, and some of the outgoing packets are discarded.

As described above, the network device 2 detects or measures the communication status of the network device 2 using a plurality of counters (25, 26, and 27). The respective count values of the counters are collected by the silent failure detection device 10 as the performance monitor information. As an example, when a polling signal is received from the silent failure detection device 10, the network device 2 transmits the count value of each counter to the silent failure detection device 10. The count values of the three counters described above are examples of the performance monitor information. The performance monitor information may include other parameters related to the communication status of the network device 2.

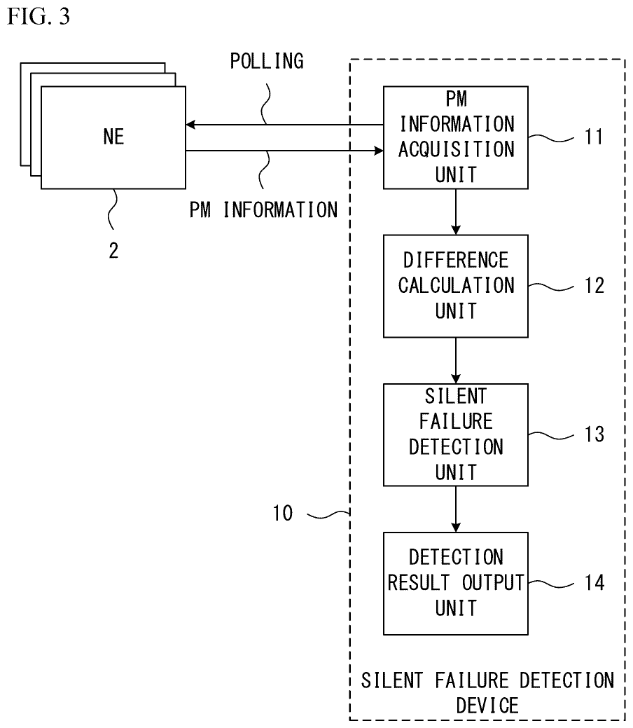

FIG. 3 illustrates a functional configuration of the silent failure detection device 10. The silent failure detection device 10 includes a PM information acquisition unit 11, a difference calculation unit 12, a silent failure detection unit 13, and a detection result output unit 14. The silent failure detection device 10 may further include other functions not illustrated in FIG. 3.

The PM information acquisition unit 11 acquires the performance monitor information from each network device 2. Specifically, the PM information acquisition unit 11 periodically transmits a polling signal to the network device 2. Then, the network device 2 that has received the polling signal transmits the respective count values of the counters (25, 26, and 27) to the silent failure detection device 10 as performance monitor information. Thus, the PM information acquisition unit 11 periodically acquires the count value of each network device 2.

The interval at which the PM information acquisition unit 11 acquires the performance monitor information is not particularly limited, and may be, for example, 15 minutes. When the number of packets discarded in each network device 2 is small, the PM information acquisition unit 11 may acquire the performance monitor information at a long interval (for example, one hour).

In the following description, the count value by the Ingress-side discard counter 25 may be referred to as an “Ingress-side discard count value”. The count value by the FCS error counter 26 may be referred to as an “FCS error count value”. The count value by the Egress-side discard counter 27 may be referred to as an “Egress-side discard count value”.

The difference calculation unit 12 calculates a difference between the count value acquired at the immediately preceding sampling time and the newly acquired count value for the performance monitor information periodically acquired by the PM information acquisition unit 11. That is, the counter difference values are calculated for the Ingress-side discard count value, the FCS error count value, and the Egress-side discard count value, respectively. In other words, the difference calculation unit 12 detects a change in the performance monitor information (the Ingress-side discard count value, the FCS error count value, and the Egress-side discard count value).

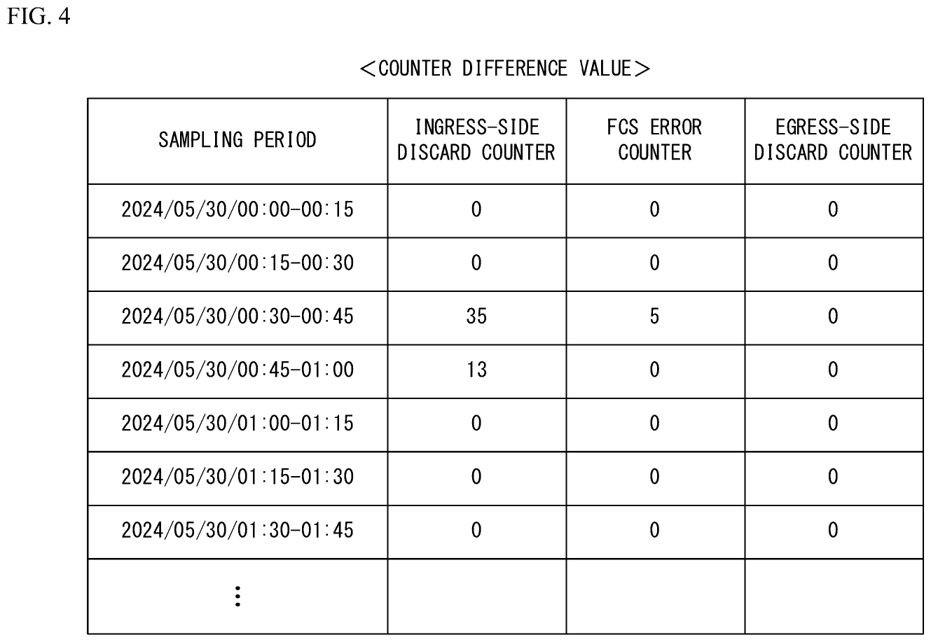

FIG. 4 illustrates counter difference values calculated by the difference calculation unit 12. In this embodiment, the PM information acquisition unit 11 acquires the performance monitor information from each network device 2 at 15-minute intervals. FIG. 4 illustrates the counter difference values for one network device 2.

In the case illustrated in FIG. 4, for example, the difference in the Ingress-side discard count value is “35” in the sampling period “2024 May 30/00:30 to 00:45”. This counter difference value represents the difference between the Ingress-side discard count value acquired at 0:30 on May 30, 2024 and the Ingress-side discard count value acquired at 0:45 on May 30, 2024. That is, this counter difference value indicates that the number of discarded packets counted by the Ingress-side discard counter 25 during 15 minutes from 0:30 to 0:45 on May 30, 2024 is 35. Therefore, this counter difference value indicates that 35 incoming packets have been discarded in the receive buffer 21 within this sampling period.

In addition, the difference in the FCS error count value in the sampling period “2024 May 30/00:30 to 00:45” is “5”. This counter difference value indicates that the number of FCS errors counted by the FCS error counter 26 during 15 minutes from 0:30 to 0:45 on May 30, 2024 is 5. That is, the counter difference value indicates that five incoming packets are discarded by the FCS processing unit 22 within the sampling period, because of the FCS error.

The counter difference value calculated by the difference calculation unit 12 is notified to the silent failure detection unit 13. At this time, the difference calculation unit 12 may notify the silent failure detection unit 13 of all the calculated counter difference values. However, when each network device 2 is operating normally in the communication network 1, the number of errors detected is considered to be small. When the transmission rate of each network device 2 is lower than the threshold level, the number of discarded packets is considered to be small. That is, during normal operation, it is assumed that each counter difference value is zero. Therefore, the difference calculation unit 12 may notify the silent failure detection unit 13 of the counter difference values only when the calculated counter difference values are not zero. This configuration reduces the memory capacity for storing the counter difference values.

The silent failure detection unit 13 detects a silent failure that occurs in the communication network 1 based on the counter difference values notified from the difference calculation unit 12. Here, the counter difference values are calculated based on the performance monitor information detected in each network device 2. Therefore, the silent failure detection unit 13 can detect a silent failure that occurs in each network device 2. Alternatively, the silent failure detection unit 13 can determine whether a silent failure has occurred in each network device 2.

The detection result output unit 14 outputs the detection result by the silent failure detection unit 13. That is, when the silent failure detection unit 13 detects the network device 2 in which the silent failure has occurred, the detection result output unit 14 outputs a notification indicating that a silent failure has occurred in the network device 2. This notification is displayed on, for example, a computer of the administrator of the communication network 1.

The silent failure detection unit 13 actually detects the network device 2 that is suspected of having a silent failure. That is, the above-described notification indicates the network device 2 that is suspected of having a silent failure. Therefore, in the following description, a notification generated when the network device 2 suspected of having a silent failure is detected may be referred to as a “failure suspicion notification”. When a silent failure is detected in the communication network 1, the administrator of the communication network 1 preferentially investigates the network device 2 indicated by the failure suspicion notification. This can reduce the time required to recover from the failure.

For example, in a certain network device 2, when the number of discarded packets received from the counterpart device increases or when the number of FCS errors in the packets received from the counterpart device increases, it is presumed that there is a problem in the software error of the counterpart device. Alternatively, it is presumed that there is a problem in the optical fiber between the counterpart device and the network device 2. Therefore, when the Ingress-side discard count value or the FCS error count value of a certain network device 2 increases, it is effective to investigate the counterpart device or the optical fiber between the counterpart device and the network device 2.

In addition, when the number of discarded packets to be transmitted or transferred increases in a certain network device 2, a software error of the network device 2 is suspected. Therefore, when the Egress-side discard count value of a certain network device 2 increases, it is effective to investigate the network device 2.

As described above, in the embodiment of the present disclosure, the silent failure detection device 10 implemented in the network management system 3 collects the performance monitor information from each network device 2, allowing the administrator of the communication network 1 to identify the location where the silent failure has occurred. Therefore, the time required to recover from the failure can be reduced.

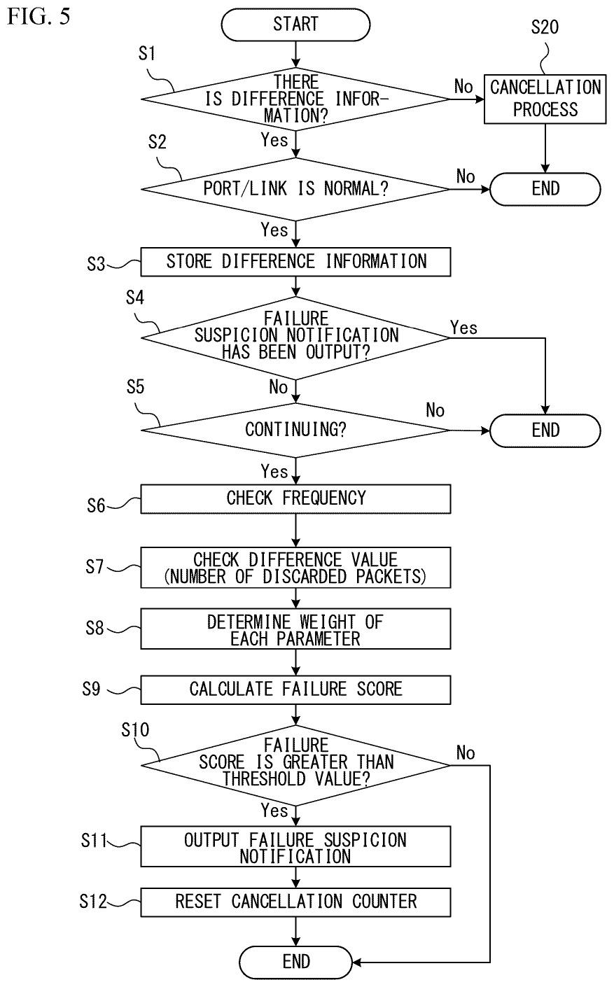

FIG. 5 is a flowchart illustrating a process of detecting a silent failure. The PM information acquisition unit 11 acquires the performance monitor information from the network device 2 at a predetermined cycle (for example, at intervals of 15 minutes). The difference calculation unit 12 calculates the difference information of each counter and notifies the silent failure detection unit 13 of the difference information every time the PM information acquisition unit 11 acquires the performance monitor information. The difference information corresponds to a change in the count value (that is, a counter difference value indicating a difference between the immediately preceding count value and the new count value). The process of this flowchart is repeatedly executed at a predetermined cycle (for example, at intervals of 15 minutes). As an example, the process of the flowchart is executed in synchronization with the timing at which the PM information acquisition unit 11 acquires the performance monitor information. The process of the flowchart is executed for each network device 2.

In S1, the silent failure detection unit 13 checks whether the silent failure detection unit 13 is notified of the difference information from the difference calculation unit 12. In this embodiment, the difference calculation unit 12 outputs the difference information when the counter difference value is not zero (that is, when the counter value changes in the network device 2). When the silent failure detection unit 13 is notified of the difference information from the difference calculation unit 12, the process of the silent failure detection unit 13 proceeds to S2. On the other hand, when the difference information is not notified from the difference calculation unit 12, the process of the silent failure detection unit 13 proceeds to S20 described later.

In S2, the silent failure detection unit 13 determines whether the port/link of the network device 2 is normal. The method of determining whether the port/link of the network device 2 is normal is not particularly limited, and any known method may be employed. For example, when a response to a polling signal for acquiring the performance monitor information is received from the network device 2, the silent failure detection unit 13 may determine that the port/link of the network device 2 is normal. Alternatively, the silent failure detection unit 13 may determine whether the port/link of the network device 2 is normal using the life-and-death monitoring signal. When the port/link is normal, the process of the silent failure detection unit 13 proceeds to S3. On the other hand, when the port/link is not normal, it is clear that a failure has occurred in the network device 2, and thus the silent failure detection unit 13 ends the process.

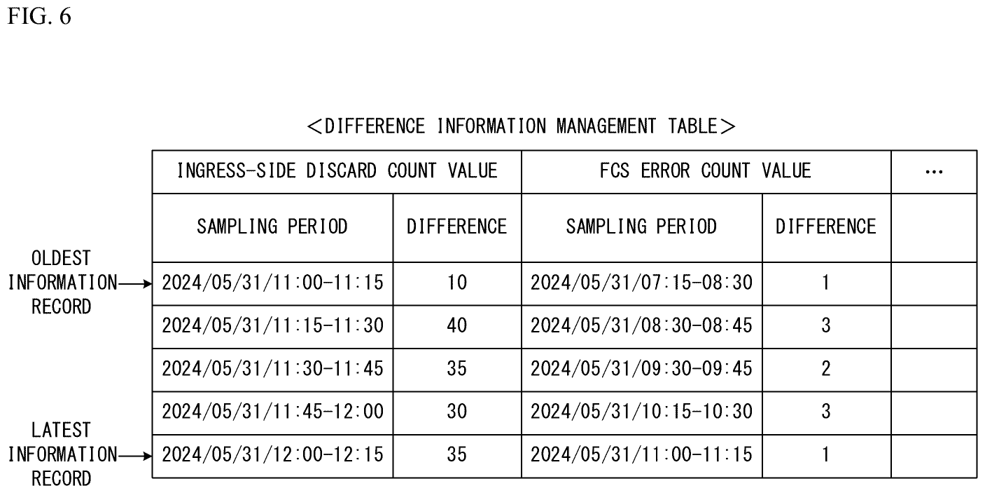

In S3, the silent failure detection unit 13 stores the difference information notified from the difference calculation unit 12 in the difference information management table. As illustrated in FIG. 6, the difference information management table manages a predetermined number of latest difference values for each count item (the Ingress-side discard count value, the FCS error count value, and the Egress-side discard count value). In this embodiment, the difference value is stored in association with the sampling period when the difference is not zero. For example, as for the Ingress-side discard count value, the difference values are recorded in five consecutive sampling periods from 11:00 to 12:15 on May 31, 2024. This information indicates the status in which the incoming packets are continuously discarded in the receive buffer 21 of the network device 2.

In S4, the silent failure detection unit 13 checks whether a failure suspicion notification is output. The failure suspicion notification is output when it is determined that a silent failure is suspected to have occurred in the process of this flowchart. When the failure suspicion notification is not output, the process of the silent failure detection unit 13 proceeds to S5. On the other hand, when the failure suspicion notification has already been output, the process of detecting the silent failure need not be executed, and thus the process of the silent failure detection unit 13 is terminated.

In S5, the silent failure detection unit 13 refers to the difference information management table and determines whether the difference information is continuously generated. Here, the difference information is generated when the values of the counters (25 to 27) of the network device 2 change. These counters (25 to 27) are incremented when a packet is discarded in the network device 2. Therefore, in S5, it is determined whether packet discarding is continuing in the network device 2. Note that “continuously” means that it is not unexpected. For example, when the difference information is recorded in the difference information management table at a frequency of once a day or more, the silent failure detection unit 13 may determine that the difference information is continuously generated. When the difference information is continuously generated, the process of the silent failure detection unit 13 proceeds to S6. On the other hand, when the difference information is not continuously generated, it is considered that the difference information is generated due to an unexpected cause other than the silent failure, and thus the process of the silent failure detection unit 13 is ended. For example, in the difference information management table, when the time difference between the date and time of the sampling period of the latest information record and the date and time of the sampling period of the latest information record immediately preceding it is one week or more, it is determined that the difference information is not continuously generated.

In S6, the silent failure detection unit 13 refers to the difference information management table and detects the frequency of generation of difference information. The frequency may be calculated based on the time difference between the date and time of the sampling period of the oldest information record and the date and time of the sampling period of the latest information record in the difference information management table. In the case illustrated in FIG. 6, the difference information is recorded at 15-minute intervals for the Ingress-side discard count value. That is, the frequency of occurrence of packet discarding in the receive buffer 21 is high. On the other hand, the difference information is recorded at intervals of about one hour for the FCS error count value. That is, the frequency of occurrence of packet discarding due to an FCS error is low.

In S7, the silent failure detection unit 13 detects a difference value by referring to the difference information management table. The difference value represents the number of packets discarded within one sampling period. The difference value may be an average value. In the case illustrated in FIG. 6, “30” is obtained as the difference value of the Ingress-side discard count value by calculating the average of the difference values of the five records. As for the FCS error count value, “2” is obtained as the average difference value.

In S8, the silent failure detection unit 13 determines the weight of the failure determination parameter. In this embodiment, a discard frequency parameter, a number-of-discards parameter, and a co-occurrence parameter are used as failure determination parameters.

The discard frequency parameter is identified in S6. In this embodiment, the weight of the discard frequency parameter is 5 to 10. Specifically, the weight is 10 when the discard frequency is high, and the weight is 5 when the discard frequency is low. For example, when the interval at which packet discarding occurs is shorter than 20 minutes, the weight of the discard frequency parameter is 10, and when the interval at which packet discarding occurs is longer than one hour, the weight of the discard frequency parameter is 5.

The number-of-discards parameter is calculated in S7. In this embodiment, the weight of the number-of-discards parameter is 1 to 10. Specifically, the weight is 10 when the number of discarded packets is large, and the weight is 1 when the number of discarded packets is small. For example, when the average number of discarded packets in the sampling period is greater than 100, the weight of the number-of-discards parameter is 10, and when the average number of discarded packets in the sampling period is less than 5, the weight of the number-of-discards parameter is 1.

The weight of the co-occurrence parameter is 1, 5, or 10 in this embodiment. Specifically, when packet discarding is detected by any one of the three counters (25 to 27) illustrated in FIG. 2, the weight is 1. When packet discarding is detected simultaneously by any two counters of the counters (25 to 27), the weight is 5. When packet discarding is detected simultaneously by all the counters (25 to 27), the weight is 10.

In S9, the silent failure detection unit 13 calculates a failure score based on the weight of each failure determination parameter determined in S8. In this embodiment, the failure score is calculated by adding the weights of the three failure determination parameters described above.

In S10 to S11, the silent failure detection unit 13 compares the failure score calculated in S9 with the predetermined threshold value. In this embodiment, the threshold value is 10. When the failure score is larger than the threshold value, the silent failure detection unit 13 determines that a silent failure may have occurred, and generates a failure suspicion notification. The failure suspicion notification includes information for identifying the network device 2 in which the failure score larger than the threshold value is detected. Then, the detection result output unit 14 outputs a failure suspicion notification. The failure suspicion notification is displayed on, for example, the computer of the administrator of the communication network 1. Thereafter, in S12, the silent failure detection unit 13 resets the cancellation counter. The cancellation counter will be described later.

When the silent failure detection unit 13 is not notified of the difference information from the difference calculation unit 12 (S1: No), the silent failure detection unit 13 executes the cancellation process in S20.

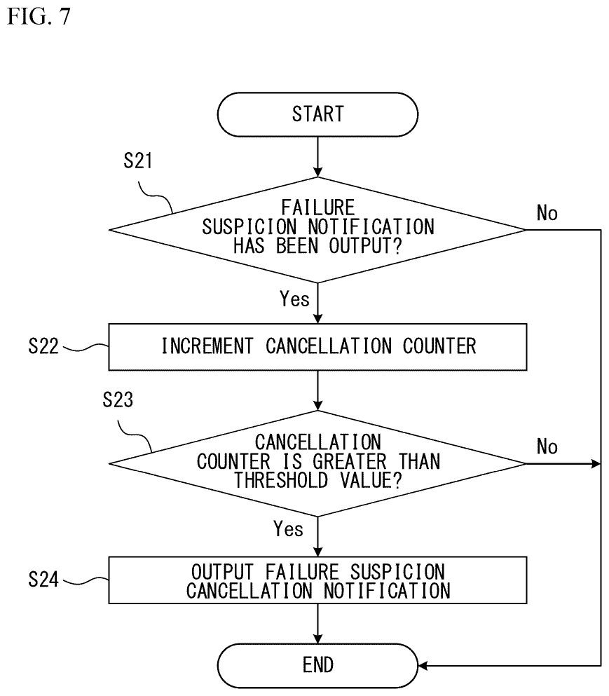

FIG. 7 is a flowchart illustrating the cancellation process. The cancellation process corresponds to S20 in the flowchart illustrated in FIG. 5. That is, the cancellation process is executed when the difference information is not notified from the difference calculation unit 12.

After outputting the failure suspicion notification, the silent failure detection unit 13 monitors whether packet discarding further occurs in the network device 2. At this time, the count value of the cancellation counter is incremented as the period of time during which no packet discarding is detected continues. When the count value of the cancellation counter becomes larger than a predetermined threshold value, the silent failure detection unit 13 determines that packet discarding related to the silent failure has not occurred, and outputs a failure suspicion cancellation notification. The details are as follows.

In S21, the silent failure detection unit 13 checks whether a failure suspicion notification is output. As described above, the failure suspicion notification is output when it is determined that a silent failure is suspected to have occurred in the process of the flowchart illustrated in FIG. 5. When the failure suspicion notification is output, the silent failure detection unit 13 increments the cancellation counter in S22. As described above, the cancellation counter is reset at S12 of the flowchart illustrated in FIG. 5. That is, when the failure suspicion notification is output, the cancellation counter is reset to zero.

In S23, the silent failure detection unit 13 compares the count value of the cancellation counter with a predetermined value. When the count value of the cancellation counter is larger than a predetermined value, the silent failure detection unit 13 outputs a failure suspicion cancellation notification in S24. The failure suspicion cancellation notification is displayed on, for example, the computer of the administrator of the communication network 1, similarly to the failure suspicion notification.

As described above, the silent failure detection unit 13 determines whether a silent failure has occurred in or around the network device 2, based on packet discarding that has occurred in the network device 2. At this time, the failure determination parameters are weighted based on the location where the packet discarding occurs in the network device 2, the frequency of the packet discarding, and the number of discarded packets, and it is determined whether the silent failure has occurred based on the total of the weighted failure determination parameters. Therefore, when the weight of each failure determination parameter is appropriately set, the accuracy of the determination of the failure suspicion is improved. Further, when no packet discarding occurs for a predetermined period, the failure suspicion notification is canceled, and therefore, it is possible to check the status and create a history in real time.

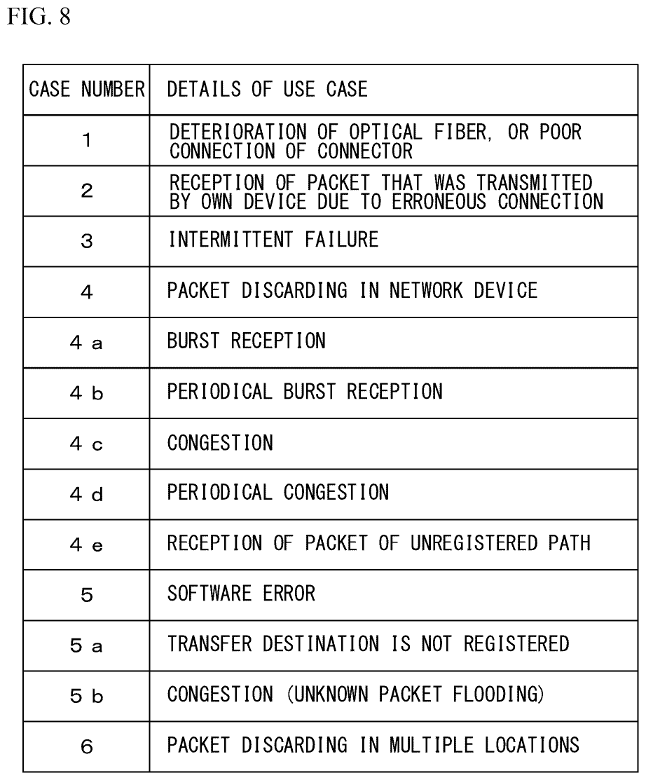

Next, various use cases that may occur in the network device 2 are applied to the procedure of the flowchart illustrated in FIG. 5. Thus, it is determined whether a silent failure is suspected for each use case. The use cases to be discussed below are illustrated in FIG. 8.

### <Case 1>

In the case 1, the optical fiber connected to the receive port of the network device 2 is degraded. Alternatively, the optical fiber connector is not properly inserted in the receive port of the network device 2. Therefore, the quality of the received optical signal is degraded, and thereby, the network device 2 may detect an FCS error. In this case, the FCS error counter 26 counts the number of packets discarded due to the FCS error.

When a packet is discarded due to an FCS error in the network device 2, difference information corresponding to the FCS error counter 26 is generated and supplied to the silent failure detection unit 13. Therefore, the determination of S1 is “Yes”. Here, it is assumed that the port/link of the network device 2 is normal (S2: Yes). It is assumed that the failure suspicion notification has not been output yet (S4: Yes). Further, when the optical fiber is degraded or when the connector of the optical fiber is not properly inserted, the quality of the received optical signal remains low and the FCS error continuously occurs, and thus the determination of S5 is “Yes”.

It is assumed that the port/link of the network device 2 is normal (S2: Yes) and the failure suspicion notification has not been output yet (S4: No) not only in the case 1 but also in other cases described later (that is, cases 2, 3, 4a to 4e, 5a, 5b, and 6).

Since the FCS error continuously occurs, the frequency of occurrence of packet discarding increases. Therefore, the weight of the discard frequency parameter is “10”. The number of discarded packets depends on the communication volume. When the communication volume is small, the weight of the number-of-discards parameter is “1”, and when the communication volume is large, the weight of the number-of-discards parameter is “10”. That is, the weight of the number-of-discards parameter is “1 to 10” according to the communication volume. In this example, it is assumed that no packets buffers are discarded in the receive buffer 21 and no packets are discarded in the transmit buffer 24. That is, the weight of the co-occurrence parameter is “1”.

Thus, the failure determination score representing the total value of the weights of the three discard determination parameters is “12” when the communication volume is small, and is “21” when the communication volume is large. That is, the failure determination score is “12 to 21”. Here, the threshold value used in S10 is “10”. Therefore, in the case 1, it is determined that the silent failure is suspected.

The silent failure detection device 10 outputs a failure suspicion notification. The failure suspicion notification includes information for identifying the network device 2 whose failure determination score exceeds the threshold value and information indicating that an FCS error has occurred.

### <Case 2>

In the case 2, the optical fiber is erroneously connected, and a packet transmitted from the network device 2 returns to the network device 2 that transmitted to the packet. Then, since the destination address of the incoming packet is the same as the address of the own device, a loop error is detected, and the incoming packet is discarded in the receive buffer 21. At this time, the Ingress-side discard counter 25 counts the number of packets discarded due to the loop error.

When a packet is discarded due to a loop error in the network device 2, difference information corresponding to the Ingress-side discard counter 25 is generated and supplied to the silent failure detection unit 13. Therefore, the determination of S1 is “Yes”. Further, since the loop error continuously occurs until the erroneous connection of the optical fiber is eliminated, the determination of S5 is “Yes”.

Since loop errors continuously occur, the frequency of occurrence of packet discarding increases. Therefore, the weight of the discard frequency parameter is “10”. The number of discarded packets depends on the communication volume. When the communication volume is small, the weight of the number-of-discards parameter is “1”, and when the communication volume is large, the weight of the number-of-discards parameter is “10”. That is, the weight of the number-of-discards parameter is “1 to 10” according to the communication volume. In this example, it is assumed that packet discarding due to an FCS error and packet discarding in the transmit buffer 24 do not occur. That is, the weight of the co-occurrence parameter is “1”.

Thus, the failure determination score representing the total value of the weights of the three discard determination parameters is “12” when the communication volume is small, and is “21” when the communication volume is large. That is, the failure determination score is “12 to 21”. Here, the threshold value used in S10 is “10”. Therefore, in the case 2, it is determined that the silent failure is suspected.

The silent failure detection device 10 outputs a failure suspicion notification. The failure suspicion notification includes information for identifying the network device 2 whose failure determination score exceeds the threshold value and information indicating that packet discarding has occurred in the receive buffer 21.

### <Case 3>

In the case 3, an electronic circuit in the network device 2 fails due to cosmic rays flying to the earth, and a specific bit in a packet processed by the electronic circuit is fixed to 0 or 1. Depending on which bit is fixed and which value is fixed, an FCS error may occur in the network device 2 that receives the packet. In this case, the FCS error counter 26 counts the number of packets discarded due to the FCS error.

When a packet is discarded due to an FCS error in the network device 2, difference information corresponding to the FCS error counter 26 is generated and supplied to the silent failure detection unit 13. Therefore, the determination of S1 is “Yes”. In the case 2, the FCS error continuously occurs until the failed electronic circuit is replaced, and thus the determination of S5 is “Yes”.

However, even when a specific bit in a packet is fixed to a specific value due to a failure of the electronic circuit, an error may not occur. For example, when a bit having an original value of “1” is fixed to “1” due to a failure, no error occurs. Thus, the frequency of packet discarding and the number of discarded packets depend on the location of the bit affected by the failure.

Therefore, “5 to 10” is assumed as the weight of the discard frequency parameter. Further, “1 to 4” is assumed as the weight of the number-of-discards parameter. In this example, it is assumed that no packets are discarded in the receive buffer 21 and no packets are discarded in the transmit buffer 24. That is, the weight of the co-occurrence parameter is “1”.

Thus, the failure determination score indicating the total value of the weights of the three discard determination parameters is “7 to 15”. Here, the threshold value used in S10 is “10”. Therefore, in the case 3, it may be determined that there is a suspicion of a silent failure depending on the location of the bit affected by the failure.

When the failure determination score exceeds 10, the silent failure detection device 10 outputs a failure suspicion notification. The failure suspicion notification includes information for identifying the network device 2 whose failure determination score exceeds the threshold value and information indicating that the FCS error has been detected.

<Case 4a>

In the case 4a, the network device 2 is not in failure, and the receive rate of the network device 2 temporarily exceeds the threshold value. That is, burst reception occurs. In this case, the receive buffer 21 of the network device 2 may overflow. That is, packets are discarded in the receive buffer 21, and the Ingress-side discard counter 25 counts the number of discarded packets.

When a packet is discarded in the receive buffer 21 of the network device 2, difference information corresponding to the Ingress-side discard counter 25 is generated and supplied to the silent failure detection unit 13. Therefore, the determination of S1 is “Yes”.

However, when the transmission rate of the counterpart device decreases and the reception rate in the network device 2 becomes lower than the threshold value, the packets are not discarded in the receive buffer 21. That is, the situation in which the incoming packet is discarded does not continue. In this case, the determination of S5 is “No”, and the failure determination score is not calculated. Therefore, in the case 4a, it is determined that a silent failure has not occurred.

<Case 4b>

In the case 4b, unlike the case 4a, the burst reception repeatedly occurs in the network device 2. That is, each time a burst reception occurs, a packet is discarded in the receive buffer 21.

When a packet is discarded in the receive buffer 21 of the network device 2, difference information corresponding to the Ingress-side discard counter 25 is generated and supplied to the silent failure detection unit 13. Therefore, the determination of S1 is “Yes”. Since the burst reception repeatedly occurs, the determination of S5 is also “Yes”.

It is assumed that the weight of the discard frequency parameter is “5 to 10”. The number of discarded packets depends on the amount of data of each burst communication. When the data amount of the burst communication is small, the weight of the number-of-discards parameter is “1”, and when the data amount of the burst communication is large, the weight of the number-of-discards parameter is “10”. That is, the weight of the number-of-discards parameter is “1 to 10” according to the data amount of the burst communication. In this example, it is assumed that packet discarding due to an FCS error and packet discarding in the transmit buffer 24 do not occur. That is, the weight of the co-occurrence parameter is “1”.

Then, the failure determination score representing the total value of the weights of the three discard determination parameters is “7” when the discard frequency is low and the communication volume is small, and is “21” when the discard frequency is high and the communication volume is large. That is, the failure determination score is “7 to 21”. Here, the threshold value used in S10 is “10”. Therefore, in the case 4b, it may be determined that there is a suspicion of a silent failure depending on the frequency of occurrence of burst communication and the amount of each burst communication.

When the failure determination score exceeds 10, the silent failure detection device 10 outputs a failure suspicion notification. The failure suspicion notification includes information for identifying the network device 2 whose failure determination score exceeds the threshold value and information indicating that packet discarding has occurred in the receive buffer 21.

<Case 4c>

In the case 4c, the network device 2 is not in failure and the transmission rate of the network device 2 temporarily exceeds the threshold value. Therefore, congestion temporarily occurs in the network device 2. In this case, the transmit buffer 24 may overflow. That is, the packet is discarded in the transmit buffer 24, and the Egress-side discard counter 27 counts the number of discarded packets.

When a packet is discarded in the transmit buffer 24 of the network device 2, difference information corresponding to the Egress-side discard counter 27 is generated and supplied to the silent failure detection unit 13. Therefore, the determination of S1 is “Yes”.

However, when the transmission rate described above becomes lower than the threshold value, packets are not discarded in the transmit buffer 24. That is, the situation in which outgoing packets are discarded does not continue. In this case, the determination of S5 is “No”, and the failure determination score is not calculated. Therefore, in the case 4c, it is determined that a silent failure has not occurred.

<Case 4d>

In the case 4d, unlike the case 4c, a situation in which the transmission rate temporarily exceeds the threshold value in the network device 2 repeatedly occurs. That is, each time burst transmission occurs, the packet is discarded in the transmit buffer 24.

When a packet is discarded in the transmit buffer 24 of the network device 2, difference information corresponding to the Egress-side discard counter 27 is generated and supplied to the silent failure detection unit 13. Therefore, the determination of S1 is “Yes”. Since burst transmission occurs repeatedly, the determination of S5 is also “Yes”.

It is assumed that the weight of the discard frequency parameter is “5 to 10”. The number-of-discards parameter depends on the amount of data of each burst communication. When the data amount of the burst communication is small, the weight of the number-of-discards parameter is “1”, and when the data amount of the burst communication is large, the weight of the number-of-discards parameter is “10”. That is, the weight of the number-of-discards parameter is “1 to 10” according to the data amount of the burst communication. In this example, it is assumed that packet discarding in the receive buffer 21 and packet discarding due to an FCS error do not occur. That is, the weight of the co-occurrence parameter is “1”.

Thus, the failure determination score representing the total value of the weights of the three discard determination parameters is “7” when the discard frequency is low and the communication volume is small, and is “21” when the discard frequency is high and the communication volume is large. That is, the failure determination score is “7 to 21”. Here, the threshold value used in S10 is “10”. Therefore, in the case 4d, it may be determined that there is a suspicion of a silent failure depending on the frequency of occurrence of burst communication and the amount of each burst communication.

When the failure determination score exceeds 10, the silent failure detection device 10 outputs a failure suspicion notification. The failure suspicion notification includes information for identifying the network device 2 whose failure determination score exceeds the threshold value, and information indicating that packet discarding has occurred in the transmit buffer 24.

<Case 4e>

In this example, the network device 2 includes a table in which path information for transferring an incoming packet to its destination is set. In this case, the network device 2 refers to the table with the path information (for example, VLANID for identifying the virtual LAN) set in the header of the incoming packet, and transfer the packet to the destination node.

In the case 4e, wrong path information is set in the header of the packet transmitted from the counterpart device. In this case, the network device 2 cannot transfer the incoming packet, and therefore the incoming packet is discarded in the receive buffer 21.

When a packet is discarded in the receive buffer 21 of the network device 2, difference information corresponding to the Ingress-side discard counter 25 is generated and supplied to the silent failure detection unit 13. Therefore, the determination of S1 is “Yes”. Further, since wrong path information continues until the setting of the counterpart device is corrected, the determination of S5 is also “Yes”.

It is assumed that the weight of the discard frequency parameter is “5 to 10”. The number of discarded packets depends on the communication volume. When the communication volume is small, the weight of the number-of-discards parameter is “1”, and when the communication volume is large, the weight of the number-of-discards parameter is “10”. That is, the weight of the number-of-discards parameter is “1 to 10” according to the communication volume. In this example, it is assumed that packet discarding due to an FCS error and packet discarding in the transmit buffer 24 do not occur. That is, the weight of the co-occurrence parameter is “1”.

Thus, the failure determination score representing the total value of the weights of the three discard determination parameters is “7” when the discard frequency is low and the communication volume is small, and is “21” when the discard frequency is high and the communication volume is large. That is, the failure determination score is “7 to 21”. Here, the threshold value used in S10 is “10”. Therefore, in the case 4e, it may be determined that there is a suspicion of a silent failure, depending on the discard frequency and the communication volume.

When the failure determination score exceeds 10, the silent failure detection device 10 outputs a failure suspicion notification. The failure suspicion notification includes information for identifying the network device 2 whose failure determination score exceeds the threshold value and information indicating that packet discarding has occurred in the receive buffer 21.

<Case 5a>

In the case 5a, the transfer destination of the incoming packet is not registered in the network device 2. For example, the case 5a may occur when the header of the incoming packet is erroneously rewritten due to a bug in software implemented in the network device 2. When the transfer destination of the incoming packet is not registered in the network device 2, the incoming packet is discarded in the receive buffer 21 or the transmit buffer 24.

When a packet is discarded in the receive buffer 21 or the transmit buffer 24 of the network device 2, difference information corresponding to the Ingress-side discard counter 25 or the Egress-side discard counter 27 is generated and supplied to the silent failure detection unit 13. Therefore, the determination of S1 is “Yes”. Further, since the state in which the transfer destination is not registered continues until the software is updated, the determination of S5 is also “Yes”.

It is assumed that the weight of the discard frequency parameter is “5 to 10”. The number-of-discards parameter depends on the communication volume. When the communication volume is small, the weight of the number-of-discards parameter is “1”, and when the communication volume is large, the weight of the number-of-discards parameter is “10”. That is, the weight of the number-of-discards parameter is “1 to 10” according to the communication volume. In this example, it is assumed that packet discarding occurs in only one of the receive buffer 21 and the transmit buffer 24. That is, the weight of the co-occurrence parameter is “1”.

Thus, the failure determination score representing the total value of the weights of the three discard determination parameters is “7” when the discard frequency is low and the communication volume is small, and is “21” when the discard frequency is high and the communication volume is large. That is, the failure determination score is “7 to 21”. Here, the threshold value used in S10 is “10”. Therefore, in the case 5a, it may be determined that there is a suspicion of a silent failure, depending on the discard frequency and the communication volume.

When the failure determination score exceeds 10, the silent failure detection device 10 outputs a failure suspicion notification. The failure suspicion notification includes information for identifying the network device 2 whose failure determination score exceeds the threshold value, and information indicating that packet discarding has occurred in the receive buffer 21 or the transmit buffer 24.

<Case 5b>

In the case 5b, when the network device 2 receives an unknown packet, packet flooding is executed. That is, when the destination of the incoming packet is not registered in the table for transferring the packet, the multicast/broadcast transfer is performed. However, since the multicast/broadcast transfer generates a large amount of outgoing packets, the transmit buffer 24 is likely to overflow.

When a packet is discarded in the transmit buffer 24 of the network device 2, difference information corresponding to the Egress-side discard counter 27 is generated and supplied to the silent failure detection unit 13. Therefore, the determination of S1 is “Yes”. Further, the multicast/broadcast transfer described above may be repeatedly executed until the cause of the generation of the unknown packet is resolved, and thus the determination of S5 is also “Yes”.

It is assumed that the weight of the discard frequency parameter is “5 to 10”. Further, when it is assumed that the number of discarded packets does not increase, the weight of the number-of-discards parameter is “1 to 4”. In this example, it is assumed that packet discarding in the receive buffer 21 and packet discarding due to an FCS error do not occur. That is, the weight of the co-occurrence parameter is “1”.

Then, the failure determination score indicating the total value of the weights of the three discard determination parameters is “7 to 15”. Here, the threshold value used in S10 is “10”. Therefore, in the case 5b, it may be determined that there is a suspicion of a silent failure.

When the failure determination score exceeds 10, the silent failure detection device 10 outputs a failure suspicion notification. This failure suspicion notification includes information for identifying the network device 2 whose failure determination score exceeds the threshold value, and information indicating that packet discarding has occurred in the transmit buffer 24.

### <Case 6>

In the case 6, packets are discarded at a plurality of locations in the network device 2. For example, some of the incoming packets are discarded due to the overflow of the receive buffer 21, and some of the packets read from the receive buffer 21 are discarded due to the FCS errors.

When a packet is discarded in the receive buffer 21 of the network device 2, difference information corresponding to the Ingress-side discard counter 25 is generated and supplied to the silent failure detection unit 13. In addition, when a packet is discarded due to an FCS error, difference information corresponding to the FCS error counter 26 is generated and supplied to the silent failure detection unit 13. Therefore, the determination of S1 is “Yes”. Further, it is assumed that the determination of S5 is “Yes”.

It is assumed that the weight of the discard frequency parameter is “5 to 10”. The number of discarded packets depends on the communication volume. When the communication volume is small, the weight of the number-of-discards parameter is “1”, and when the communication volume is large, the weight of the number-of-discards parameter is “10”. That is, the weight of the number-of-discards parameter is “1 to 10” according to the communication volume. Further, in the case 6, since packet discarding has occurred at two locations in the network device 2, the weight of the co-occurrence parameter is “5”.

Thus, the failure determination score indicating the total value of the weights of the three discard determination parameters is “11 to 25”. Here, the threshold value used in S10 is “10”. Therefore, in the case 6, it is determined that there is a suspicion of the silent failure.

The silent failure detection device 10 outputs a failure suspicion notification. The failure suspicion notification includes information for identifying the network device 2 whose failure determination score exceeds the threshold value and information indicating the location where the packet discarding has occurred.

As described above, according to the embodiment of the present disclosure, the network device 2 that is suspected of having a silent failure is identified. Therefore, the administrator of the communication network 1 can identify the location where the silent failure has occurred by using the network management system 3. For example, when the failure determination score of a network device 2X exceeds the threshold value, it is determined that a silent failure has occurred in the network device 2X or between the network device 2X and the counterpart device. In addition, the embodiment of the present disclosure has the following effects.

The silent failure detection device 10 monitors the status of the network device 2 in consideration of the continuity of packet discarding, the simultaneous occurrence of packet discarding, and the number of discarded packets, and thus has high accuracy in detecting a silent failure. For example, a case where the number of discarded packets is small but the packet discarding continues can be detected.

By monitoring the packet discarding caused by the FCS error, it is possible to detect the deterioration of the optical fiber and the state in which the connector of the optical fiber is not appropriately inserted.

Silent failures could be detected based on the traffic flow rate in each network device 2. However, in this case, when the paths among the network devices 2 become complicated, the load of the process of estimating the traffic amount becomes large, and the size of the software program for the process becomes large. In contrast, the silent failure detection device 10 detects a silent failure based on the value of the discard counter of each network device 2, and therefore the size of the software program for this purpose is small, and the amount of processing is also small. Furthermore, the cost of resources (memory and CPU) for detecting silent failures is small.

When a silent failure is detected based on the traffic flow rate in each network device 2, the accuracy of silent failure determination may be low because an estimated value of the traffic flow rate is used. In contrast, the silent failure detection device 10 detects a silent failure based on the number of packets actually discarded in the network device 2. Therefore, the accuracy of the silent failure determination is high.

In the above-described examples, the failure determination score is calculated from the three parameters (the discard frequency parameter, the number-of-discards parameter, and the co-occurrence parameter), but the embodiment of the present disclosure is not limited to this method. For example, the failure determination score may be calculated from any two of the discard frequency parameter, the number-of-discards parameter, and the co-occurrence parameter. Alternatively, the failure determination score may be calculated from four or more parameters.

### <Hardware Configuration>

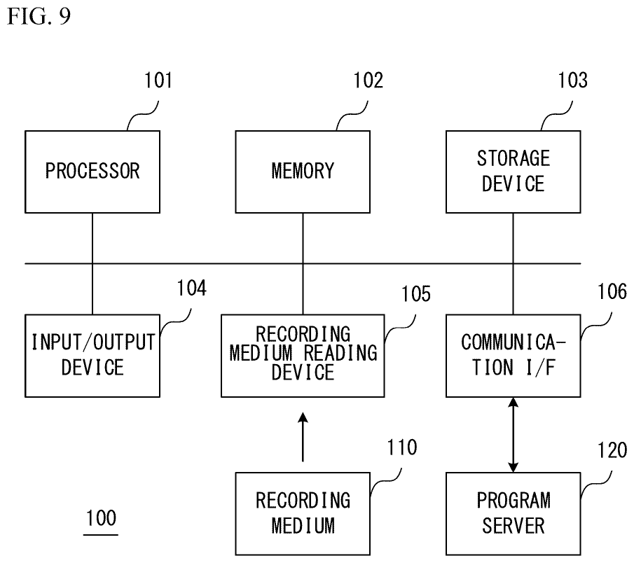

FIG. 9 illustrates a hardware configuration of the silent failure detection device 10 (or the network management system 3). The silent failure detection device 10 is implemented by a computer system 100 including a processor 101, a memory 102, a storage device 103, an input/output device 104, a recording medium reading device 105, and a communication interface 106.

The processor 101 executes a silent failure detection program stored in the storage device 103. The processor 101 executes the silent failure detection program to provide the functions of the PM information acquisition unit 11, the difference calculation unit 12, the silent failure detection unit 13, and the detection result output unit 14 illustrated in FIG. 3. The memory 102 is used as a work area of the processor 101. The storage device 103 stores the silent failure detection program and other programs. The difference information management table illustrated in FIG. 6 is stored in the memory 102 or the storage device 103.

The input/output device 104 may include an input device such as a keyboard, a mouse, a touch panel, or a microphone. The input/output device 104 may also include an output device such as a display device or a speaker. The recording medium reading device 105 can acquire data and information recorded in a recording medium 110. The recording medium 110 is a removable recording medium that can be attached to and detached from the computer system 100. The recording medium 110 is realized by, for example, a semiconductor memory, a medium that records signals by optical action, or a medium that records signals by magnetic action. The silent failure detection program may be provided to the computer system 100 from the recording medium 110. The communication interface 106 provides a function of connecting to a network. When the silent failure detection program is stored in a program server 120, the computer system 100 may acquire the silent failure detection program from the program server 120.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A silent failure detection device comprising:
a memory; and
a processor coupled to the memory and configured to:
periodically acquire performance monitor information indicating a communication status from each of a plurality of network devices constituting a communication network; and
detect a silent failure occurring in the communication network based on the performance monitor information acquired,
wherein the processor is further configured to:
determine values of a plurality of failure determination parameters based on the performance monitor information; and
determine whether a silent failure has occurred in the communication network based on a failure determination score calculated from the values of the plurality of failure determination parameters.

2. The silent failure detection device according to claim 1, wherein the performance monitor information acquired from a first network device of the plurality of network devices includes first counter information indicating the number of packets discarded in a receive buffer of the first network device, second counter information indicating the number of packets discarded due to an error in the first network device, and third counter information indicating the number of packets discarded in a transmit buffer of the first network device.

3. The silent failure detection device according to claim 1,
wherein the performance monitor information acquired from a first network device of the plurality of network devices includes counter information indicating the number of packets discarded in the first network device,
wherein the plurality of failure determination parameters include a first parameter indicating a frequency at which packets are discarded in the first network device and a second parameter indicating the number of packets discarded in the first network device, and
wherein the processor is further configured to:
increase a value of the first parameter as the frequency at which packets are discarded in the first network device increases;
increase a value of the second parameter as the number of packets discarded in the first network device increases; and
calculate the failure determination score by adding the value of the first parameter and the value of the second parameter; and
determine that a silent failure has occurred in the first network device or between the first network device and a counterpart device of the first network device when the failure determination score is greater than a predetermined threshold value.

4. The silent failure detection device according to claim 3,
wherein the plurality of failure determination parameters further include a third parameter indicating the number of locations where packet discarding occurs in the first network device, and
wherein the processor is further configured to:
increase a value of the third parameter as the number of locations where packet discarding occurs in the first network device increases;
calculate the failure determination score by adding the value of the first parameter, the value of the second parameter, and the value of the third parameter; and
determine that a silent failure has occurred in the first network device or between the first network device and a counterpart device of the first network device when the failure determination score is larger than a predetermined threshold value.

5. The silent failure detection device according to claim 3, wherein the processor is further configured to:
calculate a difference between a number indicated by the counter information acquired immediately before and a number indicated by the counter information newly acquired, and
determine whether a silent failure has occurred in the communication network when the difference is not zero.

6. A silent failure detection method comprising:
periodically acquiring performance monitor information indicating a communication status from each of a plurality of network devices constituting a communication network;
determining values of a plurality of failure determination parameters based on the performance monitor information acquired; and
determining whether a silent failure has occurred in the communication network based on a failure determination score calculated from the values of the plurality of failure determination parameters.
